(19) United States
(12) Patent Application Publication
(10) Pub. No.: US 2016/0108512 A1
(43) Pub. Date: Apr. 21, 2016

(54) METHOD OF DEPOSITING TANTALUM TO FORM A TANTALUM COATING

(71) Applicant: Endurance Technologies Inc., Calgary (CA)

(72) Inventor: Eugene Medvedovski, Calgary (CA)

(73) Assignee: Endurance Technologies Inc., Calgary (CA)

(21) Appl. No.: 14/271,903

(22) Filed: May 7, 2014

(51) Int. Cl. C23C 10/28; B32B 15/01; C23C 10/02

(52) U.S. Cl. CPC C23C 10/28; C23C 10/02; B32B 15/013

(57) ABSTRACT

A method of depositing tantalum to form a tantalum coating on substrates is provided. The method comprises preparing a tantalum-containing mixture having a tantalum donor, a halide activator, and a tantalum halide activator; preparing a substrate for deposition of the tantalum from the tantalum-containing mixture; and heating the substrate and the tantalum-containing mixture to a given temperature to deposit the tantalum on the substrate.

### FIELD OF INVENTION

This invention relates to corrosion resistant coatings and specifically to methods of depositing tantalum on a substrate to form a tantalum coating.

### BACKGROUND

Tantalum (Ta) is a highly corrosion resistant metal, and has applications in manufacturing components used in chemical processing in acidic conditions at elevated temperatures, power generation (especially where hydrogen fuel is used), and other applications where other materials such as metals, alloys, ceramics, and composites cannot withstand the corrosive environment. However, tantalum is an expensive metal. Although monolithic tantalum components can be employed in the abovementioned corrosive environments, their cost is extremely high. The high costs become especially prohibitive when components are large and have to be monolithic; for instance, pipes and tubes, cyclones, reducers, diaphragms, reactor components and the like. High cost of tantalum is among the major limiting factors of its use in industry. Use of Ta-based coatings on steels and other lower-cost alloys has been used to reduce the cost of tantalum used, while retaining some of its corrosion resistant properties.

Physical methods, such as physical vapor deposition and spraying of metallic powders have been used to form Ta and Ta-based coatings on metallic components. However, these techniques are not well suited for coating components with large surface areas and/or complex shapes and/or where the interior surfaces must also be protected. An example would be tubular goods, where it is desirable to coat the inner surface of the tube.

Simple dipping and other related processes, such as sol-gel, are limited in that they deposit very thin tantalum layers (a few microns) and provide poor adhesion and bonding of the coating to the base material.

Chemical vapor deposition (CVD) methods allow deposition of protective layers on complex shapes. They also provide satisfactory bonding of the protective layer to the substrate (base material) through high-temperature diffusion of the protective metal into the substrate material. In CVD methods, the substrate is placed into a reaction chamber, followed by controlled introduction and flow of a reactive gas containing the protective metal, for example tantalum, and a carrier gas, and in many instances also a reducing gas. During the CVD process, the deposited metal diffuses into and may chemically interact with the substrate material.

Ta-based coatings have been obtained using CVD methods, where the formation of Ta occurs through the reduction of a tantalum halide by a reducing gas such as hydrogen, nitrogen, or ammonia. For example, chemical reaction of 2TaCl_{5 (g)}+5H_{2 (g)}→2Ta₍ₛ₎+10HCl_{(g)} may be employed for Ta deposition. Alternatively, TaF₅ and TaBr₅ can be used as the tantalum source. In the case of use of N₂ or NH₃ gases, a tantalum nitride coating can be obtained.

It is also possible to carry out CVD of tantalum using solid precursors. To obtain tantalum halide gas from solid precursors, chlorination of metallic powder has been used in accordance with the reactions: 2Ta₍ₛ₎+5Cl_{2 (g)}→2TaCl_{5 (g)} or 2Ta₍ₛ₎+10HCl_{(g)}→2TaCl_{5 (g)}+5H_{2 (g)}. The tantalum halide gas can then be used as described above to deposit tantalum on the substrate.

These CVD processes require expensive equipment and instrumentation to properly control the gaseous phase. Moreover, the use of chlorine, bromine, hydrogen, and tantalum halide gases poses significant hazards. Generally, these processes are expensive, low yield, and cannot be used for coating large size components, e.g. long tubing. In some cases, the design of the reaction chamber and the physical principles of gas flow in the chamber do not allow for the formation of uniform coating layers over the entire area of the substrate; for example, the thickness and the composition of the coating may be variable, resulting in inconsistent corrosion resistance at different areas of the substrate.

### SUMMARY OF THE INVENTION

Provided herein is a method for coating substrates, including substrates with complex shapes, in a cost effective manner, and without the use of hazardous and/or expensive gaseous precursors. A powder containing a tantalum donor, a halide activator, and a tantalum halide activator are used to surround a pre-treated substrate, and the powder and substrate are heated, for example in a reaction vessel.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XYY, YZ, ZZ, and the like). Similar logic can be applied for two or more items in any occurrence of “at least one . . . ” and “one or more . . . ” language.

According to an aspect of the present specification there is provided a method comprising preparing a tantalum-containing mixture having a tantalum donor, a halide activator, and a tantalum halide activator; preparing a substrate for deposition of tantalum from the tantalum-containing mixture; and heating the substrate and the tantalum-containing mixture to a given temperature to deposit the tantalum on the substrate.

The halide activator and the tantalum halide activator can each comprise a same halogen; or, the halide activator and the tantalum halide activator can each comprise a different respective halogen.

The tantalum donor can comprise a compound selected from the group consisting of tantalum, tantalum carbide, tantalum boride, tantalum nitride, and a tantalum intermetallide comprising one or more of Fe, Ti, Cr, Ni, and Nb, and the like.

The tantalum donor can comprise a mixture of tantalum powder and a tantalum compound, the tantalum compound selected from the group consisting of tantalum carbide, tantalum boride, tantalum nitride, and a tantalum intermetallide comprising one or more of Fe, Ti, Cr, Ni, and Nb, and the like.

A ratio of a weight of the tantalum powder to a weight of the tantalum compound can be greater than about 2.

A ratio of a weight of the tantalum powder to a weight of the tantalum compound can be greater than about 3.

The tantalum donor can comprise one or more tantalum-containing compounds and an element, the element selected from the group consisting of Nb, Mo, Cr, Ti, Co, Ni, Zr, Hf, and V, the tantalum donor having greater than 50 weight percent of the one or more tantalum-containing compounds.

The halide activator can be selected from the group consisting of ammonium fluoride, ammonium chloride, and ammonium bromide.

The tantalum halide activator can be selected from the group consisting of tantalum fluoride, tantalum chloride, tantalum bromide, K₂TaF₇, and Na₂TaF₇.

A ratio of a weight of the tantalum halide activator to a weight of the halide activator can be greater than about 5.

A ratio of a weight of the tantalum halide activator to a weight of the halide activator can be greater than about 7.5.

The tantalum-containing mixture can further comprise an inert filler.

The inert filler can be selected from the group consisting of Al₂O₃, ZrO₂, TiO₂, and Cr₂O₃.

The tantalum-containing mixture can comprise: a weight percent of the tantalum donor in a range of about 8% to about 50%, a weight percent of a combination of the halide activator and the tantalum halide activator in a range of about 1% to about 20%; and, a weight percent of the inert filler in a range of about 49% to about 91%.

The tantalum-containing mixture can comprise: a weight percent of the tantalum donor in a range of about 10% to about 25%; a weight percent of a combination of the halide activator and the tantalum halide activator in a range of about 3% to about 15%; and a weight percent of the inert filler in a range of about 60% to about 87%.

The tantalum-containing mixture can comprise: a weight percent of the tantalum donor in a range of about 12% to about 18%; a weight percent of a combination of the halide activator and the tantalum halide activator in a range of about 4% to about 10%; and a weight percent of the inert filler in a range of about 72% to 86%.

Preparing the substrate can comprise one or more of: washing the substrate; mechanical cleaning of the substrate; and, acid treatment of the substrate.

The method can further comprise placing the tantalum-containing mixture in contact with surfaces of the substrate prior to the heating.

The given temperature can be in a range of about 850° C. to about 1150° C.

The substrate and the tantalum-containing mixture can be treated at the given temperature for a length of time in a range of about 5 hours to about 20 hours.

The tantalum-containing mixture can comprise a powder.

The tantalum donor can comprise a powder including particles below about 200 mesh.

The tantalum donor can comprise a powder including particles below about 325 mesh.

The halide activator and the tantalum halide activator can each comprise powders including particles below about 200 mesh.

The method can further comprise after the heating, reusing the tantalum-containing mixture in a subsequent tantalum deposition after adding at least one of the following to the tantalum-containing mixture: more of the tantalum donor, more of the halide activator, more of the tantalum halide activator, and an inert filler.

The substrate can have a multi-faceted surface and the tantalum-containing mixture can be placed in contact with one or more facets of the multi-faceted surface prior to the heating.

According to another aspect of the present specification there is provided a metallic substrate having a coating, the coating comprising: an outer tantalum-rich intermetallide layer having a weight percent of tantalum greater than about 60%, the outer tantalum-rich intermetallide layer protecting the metallic substrate against corrosion; and, an intermediate transition layer having an intermetallide of tantalum and at least one metal from the metallic substrate, the intermediate transition layer having a weight percent of tantalum in a range of about 35% to about 55%, the intermediate transition layer bonding the outer tantalum-rich intermetallide layer to the metallic substrate.

The coating can have a thickness of at least 3 μm.

The outer tantalum-rich intermetallide layer can comprise: an outer layer having a weight percent of tantalum in a range of about 70% to about 85%; and, an inner layer having a weight percent of tantalum in a range of about 60% to about 70%.

The outer layer can have a thickness below 2 μm.

### DESCRIPTION OF THE DRAWINGS

For a better understanding of the various implementations described herein and to show more clearly how they may be carried into effect, reference will now be made, by way of example only, to the accompanying drawings in which:

FIG. 1 depicts a method depositing tantalum on a substrate to form a tantalum coating, according to non-limiting implementations.

FIG. 2 depicts both transverse and longitudinal cross-sectional views of a deposition apparatus used to carry out an example implementation of the method of the present invention, according to non-limiting implementations.

FIG. 3 is a cross-sectional view of a deposition apparatus used to carry out an example implementation of the method of the present invention, according to non-limiting implementations.

FIG. 4 is a longitudinal cross-sectional view of a deposition apparatus used to carry out an example implementation of the method of the present invention, according to non-limiting implementations.

FIG. 5 is an axial cross-sectional view of the deposition apparatus of FIG. 4, according to non-limiting implementations.

FIG. 6 is a cross-sectional view of a substrate, according to non-limiting implementations.

FIG. 7 is a cross-sectional view of a substrate with a two-layer tantalum coating, according to non-limiting implementations.

FIG. 8 is a cross-sectional view of a substrate with a three-layer tantalum coating, according to non-limiting implementations.

FIG. 9 is an optical micrograph of a cross-section of a substrate showing a tantalum-rich coating and an intermediate transition layer, according to non-limiting implementations.

### DETAILED DESCRIPTION

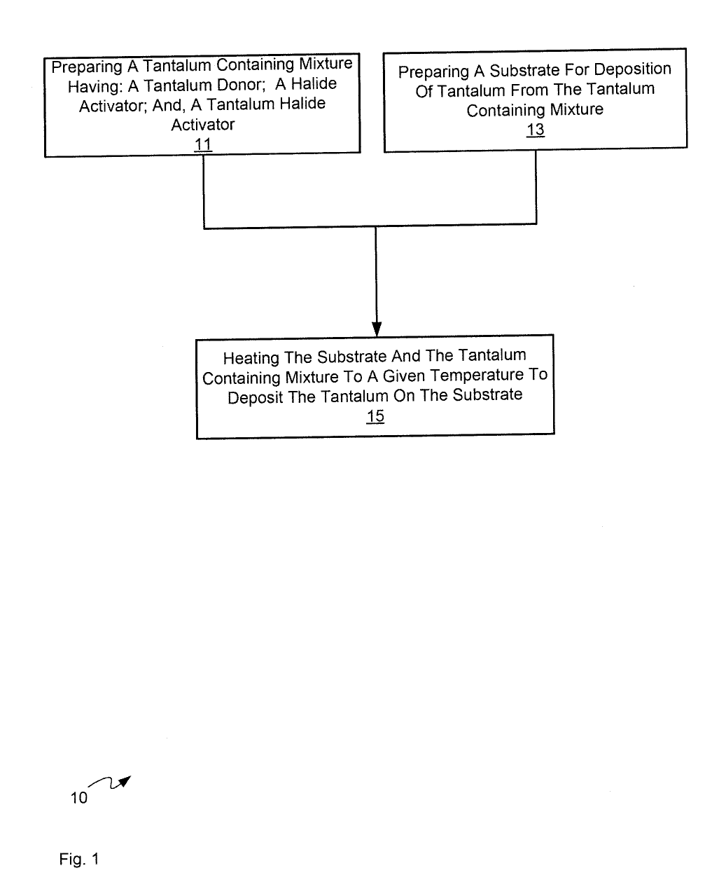

Attention is first directed to FIG. 1 which depicts a flowchart illustrating a method 10 of depositing tantalum on a substrate to form a tantalum coating, according to non-limiting implementations. It is to be emphasized, that method 10 need not be performed in the exact sequence as shown, unless otherwise indicated; and likewise various blocks can be performed in parallel rather than in sequence; hence the elements of method 10 are referred to herein as “blocks” rather than “steps”.

At block 11 a tantalum-containing mixture is prepared comprising: a tantalum donor; a halide activator; and, a tantalum halide activator. At block 13, a substrate is prepared for deposition of tantalum from the tantalum-containing mixture. Blocks 11 and 13 can be performed in parallel and/or in any order. At block 15, the substrate and the tantalum-containing mixture are heated to a given temperature to deposit the tantalum on the substrate. Block 15 can include placing the substrate and the tantalum-containing mixture into a reaction vessel and heating the reaction vessel, as described below. Method 10 will now be described in further detail.

The tantalum-containing mixture prepared at block 11 comprises a tantalum donor, a halide activator, and a tantalum halide activator.

The tantalum donor can comprise tantalum powder alone; alternatively, tantalum powder can be mixed with other Ta-compound powders (TaE, where E denotes an element), including, but not limited to, tantalum carbide (TaC), tantalum boride (TaB), tantalum nitride (TaN) and/or a mixture of these Ta-compounds. In some implementations, the tantalum powder can be mixed with a tantalum intermetallide powder, TaMe, where Me denotes a metal. The metal can be selected from the consisting Fe, Ti, Cr, Ni, Nb, and the like. In some implementations, the tantalum powder can be mixed with a combination of one or more TaE powders and one or more TaMe powders.

In addition, the Ta donor can also comprise other elements including, but not limited to, Nb, Mo, Cr, Ti, Co, Ni, Zr, Hf, and V, where the tantalum donor has greater than 50 weight percent of the one or more tantalum-containing compounds. These additional elements can provide additional chemical resistance, as well as lower the cost of the Ta donor.

Indeed, as elemental tantalum can be quite expensive, when the tantalum donor comprises a combination of elemental tantalum powder and TaE compounds the cost of the tantalum donor is reduced as compared to when the tantalum donor comprises only elemental tantalum powder. In addition, TaE compounds can react more slowly with the activators tantalum-containing mixture when heated at block 15, as compared to elemental tantalum alone. Hence, addition of TaE to the tantalum-containing mixture can provide a means for controlling a rate of reaction of the tantalum donor with the activators and hence the rate of deposition of tantalum on the substrate.

However, as amounts of Ta in the tantalum donor are increased, the thickness of the layer of corrosion resistant tantalum deposited on the substrate can increase. Hence, in some implementations, the ratio of the weight of the tantalum powder to the weight of the TaE can be greater than about 2. In yet other implementations, the ratio of the weight of the tantalum powder to the weight of the TaE can be greater than about 3.

The halide activator and the tantalum halide activator can comprise the same halogen, or different halogens.

The halide activator can include, but is not limited to, ammonium halides, such as NH₄Cl, NH₄F, NH₄Br, or a combination thereof. The tantalum halide activator can include, but is not limited to TaF₅, TaCl₅, TaBr₅, or more complex halides, such as K₂TaF₇, Na₂TaF₇, or a combination thereof.

Block 11 can further comprise mixing the components of the tantalum-containing mixture in a dry state.

Attention is next directed to block 13, where the substrate is prepared for deposition of tantalum from the tantalum-containing mixture. The substrate can be metallic and can be made of materials that include, but are not limited to: steels, carbon steels, stainless steels, ferrous alloys and non-ferrous alloys. Steels and/or ferrous alloys and/or non-ferrous alloys can include different contents of alloying elements, including, but not limited to, Cr, Ni, Inconel™, Fe, Cr, Ni, Co, and Ti.

Preparing the substrate at block 13 can include one or more surface treatments to remove foreign particles, rust, and scale, and to activate the surface to facilitate diffusion of Ta into the substrate material. Preparing the substrate can comprise one or more of mechanical cleaning, acid treatment, and washing.

Mechanical cleaning can include, but is not limited to, cleaning of the surface with brushes and blowers, and blasting to make the surface smoother and more activated while minimizing residual oxide scale. Blasting of the metallic substrate surface can be carried out using beads, grits, and the like, for example, glass beads, silica or alumina sand, and other grits. Blasting can contribute to providing a smooth surface and removing the scale from any previous metal forming steps.

Acid treatment of the substrate can comprise treatment with different acidic solutions including, but not limited to, solutions of hydrochloric, nitric, phosphoric, sulfuric, oxalic, citric, and acetic acids. The type of acid, its concentration and the time of exposure of the substrate material in the acidic solution can be selected based on the nature and composition of the substrate and the configuration of the substrate component, so that a residual oxide layer is removed during the acidic treatment.

In addition to removing any residual oxide layer, acid treatment can contribute to activating the substrate surface by creating vacancies and/or more vacancies in the surface structure. Activation can be particularly beneficial when stainless steels and other alloys with high contents of alloying elements are used because these materials have rather dense structures, and the alloying elements, for example Ni, Cr, Co, and Ti, inhibit inward diffusion of tantalum into the substrate. In addition, other ingredients can be added to the acidic solution to promote surface activation and to reduce the environmental impact of the acid treatment waste. Such other ingredients can include, but are not limited to, hydrogen peroxide. In addition to acid treatment, the mechanical cleaning can also contribute to the activation of the substrate surface by creating stresses and dislocations in the surface.

In some implementations, preparing the substrate at block 13 can include washing the substrate using solvents. The substrate can be washed with solvents that include, but are not limited to, acetone, carbon tetrachloride, and alcohol, and then dried using a stream of a gas such as air, and the like. A combination of mechanical cleaning, acid treatment and washing with a solvent can also be used.

In any event, once the tantalum-containing mixture is prepared and the surface of the substrate is prepared, the substrate and the tantalum-containing mixture are heated to a given temperature to deposited tantalum on the substrate, for example inside a reaction vessel. In some implementations, the tantalum-containing mixture is placed in contact with substrate within the reaction vessel, while in other implementations, the tantalum-containing mixture can be placed adjacent to the substrate within the reaction vessel. For example, as described below, the substrate can be covered and/or partially covered with the tantalum-containing mixture within the reaction vessel. Alternatively, when the substrate comprises at least a partially enclosed space, such as a tube, a pipe, and the like), the tantalum-containing mixture can be placed inside the space.

Thereafter, the substrate and the tantalum-containing mixture are heated to a given temperature to deposited tantalum on the substrate.

The heating at block 15 can include, but is not limited to, a heating stage, a soak stage and a cooling stage. During the heating stage, the activators react with the tantalum donor to form tantalum halide vapors and/or Ta vapors which are deposited onto the substrate, and diffuse into the substrate during at elevated temperatures of at least the soak stage, as described hereafter. Such diffusion can start to occur during the heating stage and/or can continue during a cooling stage.

Upon heating to a range of about 100° C. to about 200° C. the halide activator(s) in the tantalum-containing mixture decompose to form hydrogen halide vapors. Furthermore, upon heating to a range of about 550° C. to about 700° C., the tantalum halide activator(s) in the tantalum-containing mixture also form tantalum halide vapors; gaseous halogen can also form. Tantalum in the tantalum powder can react with the hydrogen halide vapors at higher temperatures yielding tantalum halide vapors and/or gas, as well as other gases, to produce tantalum halide vapors with lowered halogen content. More complex tantalum halide activators, including but not limited to K₂TaF7 and Na₂TaF₇, decompose at elevated temperatures (greater than 600° C.) yielding gaseous tantalum halides. The combination of a halide activator and a tantalum halide activator generally provides a two-step activation allowing for tantalum halide vapor formation over a temperature range that creates more efficient interaction with tantalum donors Ta and TaE. The two-step activation also allows for a controlled interaction of the tantalum halide vapor with the substrate.

In any event, the tantalum gas and/or vapor, and the tantalum-halide gas and/or vapor deposit on and react with the metals in the substrate yielding tantalum and tantalum intermetallides in solid form, which further diffuse into the substrate with further formation of tantalum intermetallides. The metal in the substrate can also react with the various halogen vapors to form metal halogens in vapor and/or gas form, which can further react with tantalum in the tantalum-containing mixture, yielding further tantalum halides, which again react with the substrate.

In other words, during the heating, gases and/or vapors containing Ta-species are formed, and the gases and/or vapors react with the tantalum-containing mixture to form further tantalum containing gases, which interact with the substrate so that tantalum is deposited at the substrate and/or tantalum intermetallides are formed. Tantalum and tantalum intermetallides diffuse into the substrate (inward diffusion) while metals, and other elements, in the substrate diffuse in the opposite direction (outward diffusion) yielding tantalum intermetallides (with decreasing tantalum contents further into the substrate. At the same time at high temperatures (for example during the soak stage at the final temperature) a consolidation of a tantalum intermetallide layer occurs, where the tantalum intermetallide layer becomes denser.

For example, when NH₄Cl is used as the halide activator, NH₄Cl decomposes at temperatures around 200° C.:

NH₄Cl→NH_{3(g)}+HCl_{(g)} Equation 1

As the temperature increases, the HCl gas (e.g. a hydrogen halide vapor) can then react with Ta metal and TaE in the tantalum-containing mixture to form intermediate tantalum halides, which can in turn decompose to form Ta vapour, which is deposited onto the substrate.

Similarly, when K₂TaF₇ is used as the tantalum halide activator, K₂TaF₇ decomposes at temperatures between about 600° C. and about 650° C.:

K₂TaF₇→2KF_{(g)}+TaF_{5(g)} Equation 2

As the temperature increases, the TaF₅ gas can then react with further Ta metal in the tantalum-containing mixture to form further intermediate tantalum halides, which can be partially reduced to form more Ta vapour, which is deposited onto the substrate.

Hence, the combination of the reaction of the Ta in the tantalum-containing mixture with the products of decomposition of the halide activator and the tantalum halide activator decomposing during the heating leads to deposition of Ta on the substrate. Further heating, including at the soak stage, leads to diffusion of the Ta into the substrate followed by the subsequent formation of Ta-intermetallides.

As an amount of tantalum halide activator in the tantalum-containing mixture is increased relative to the respective amount of the halide activator, formation of the hydrogen halide from the halide activator is reduced, thereby reducing pressure inside the reaction vessel (discussed in more detail below); furthermore, slower and more extended reaction of the gases with the tantalum donor and with the substrate can occur. This in turn contributes to deposition of a more uniform tantalum-rich layer, which can then bond to the substrate more securely as a result of the thermal diffusion of at least some of the deposited tantalum into the substrate. In some implementations, the ratio of the weight of the tantalum halide activator to the weight of the halide activator is greater than about 5. In yet other implementations, the ratio of the weight of the tantalum halide activator to the weight of the halide activator is greater than about 7.5.

In some implementations, the tantalum-containing mixture can also comprise an inert filler, which can include, but is not limited to, oxide powders such as Al₂O₃, ZrO₂, TiO₂, Cr₂O₃ and combinations thereof. In some implementations, Al₂O₃ can be used as Al₂O₃ can be a cost-effective inert filler.

In some implementations, each of the tantalum donor, the halide activator and tantalum halide activator can comprise powders. Indeed, use of powders generally promotes the reaction between the components of the tantalum-containing mixture. In some implementations the tantalum donor can comprise powders having particles below about 200 mesh; in yet further implementations, the tantalum donor can comprise powders having particles below about 325 mesh. Each of the halide activator and tantalum halide activator can comprise powders having particles below about 200 mesh. As the particle size of powders is increased, the rate of reaction between the tantalum donor and the activators can decrease; above threshold particle sizes, the rate of reaction can become too low to be useful; further, as the particle sizes is decreased, the reaction rate can become too high and difficult to control, which can cause an excessive formation of gaseous reaction products and contribute to elevated pressures in the reaction vessel.

As the tantalum-containing mixture is heated, the tantalum donor and the activators react to form gaseous products, as described above. As such, the tantalum donor can become partially or completely depleted of tantalum. Similarly, the activators can become partially or completely consumed. The inert filler remains largely unaffected by the process. At the end of method 10, for example after the cooling stage, in some implementations, the remaining powders can be collected and used as the inert filler in a subsequent applications of method 10. Hence, the inert filler, and any remaining tantalum donor and activators from a previous deposition can be reused, and replenished with fresh tantalum donor, fresh activators, and fresh inert filler as needed. This recycling of tantalum donor, activators, and inert filler can reduce processing cost without sacrificing the quality of the tantalum coating.

In some implementations, the tantalum-containing mixture can comprise a weight percent of the tantalum donor in the range of about 8% to about 50%, a weight percent of a combination of the halide activator and the tantalum halide activator in the range of about 1% to about 20%; and, a weight percent of the inert filler in the range of about 49% to about 91%. In other implementations, the tantalum-containing mixture can comprise a weight percent of the tantalum donor in the range of about 10% to about 25%; a weight percent of a combination of the halide activator and the tantalum halide activator in the range of about 3% to about 15%; and a weight percent of the inert filler in the range of about 60% to about 87%. In yet another implementation, the tantalum-containing mixture can comprise a weight percent of the tantalum donor in the range of about 12% to about 18%; a weight percent of a combination of the halide activator and the tantalum halide activator in the range of about 4% to about 10%; and a weight percent of the inert filler in the range of about 72% to about 86%.

Such ratios can provide: a sufficient level of activation, i.e. interaction of the halide gases with the tantalum donor; sufficient fluidity of the powders so that they pour into the reaction vessel and are discharged from the reaction vessel after deposition without “caking” and agglomeration; and deposition and formation of a smooth, consolidated coating on the substrate surface.

When amounts of the activators are smaller than these ranges, the interaction of the activator vapours with the tantalum donor can be insufficient, leading to insufficient further formation of gaseous tantalum halide species, insufficient deposition of tantalum on the substrate, and insufficient diffusion of the deposited tantalum into the substrate. As a result, the formation of Ta-intermetallides can be insufficient and the thickness of the tantalum coating can be very thin (below 2 μm) and uneven, which would hinder the coating's ability to provide satisfactory protection against corrosion.

When amounts of the activators are greater than these ranges, the halide activator and tantalum halide activator vapors can form too quickly and in too great a quantity, creating conditions that can be hard to control and can cause elevated pressures in the reaction vessel. As a result, air bubbles can form in the tantalum deposited on the substrate with loosely bonded Ta-intermetallides and a rough surface appearance. In this case, chipping and micro-cracking can occur during the handling of the obtained coated components causing reduced integrity and performance of the coating.

When the amount of the tantalum donor is lower than these ranges, formation of tantalum intermetallides and the thickness of the tantalum coating can be insufficient. If the amounts of the tantalum donor powders are greater than proposed, formation of tantalum intermetallides and the thickness of the tantalum layer cannot necessarily increase. However, considering the high cost of tantalum, amounts of tantalum donor greater than these ranges can increase the cost of the process without appreciable improvements in the tantalum coating.

According to some implementations, once the tantalum-containing mixture is prepared at block 11, and the substrate is prepared at block 13, each of the tantalum-containing mixture and the substrate can be transferred into a reaction vessel, for example prior to block 15, for heating.

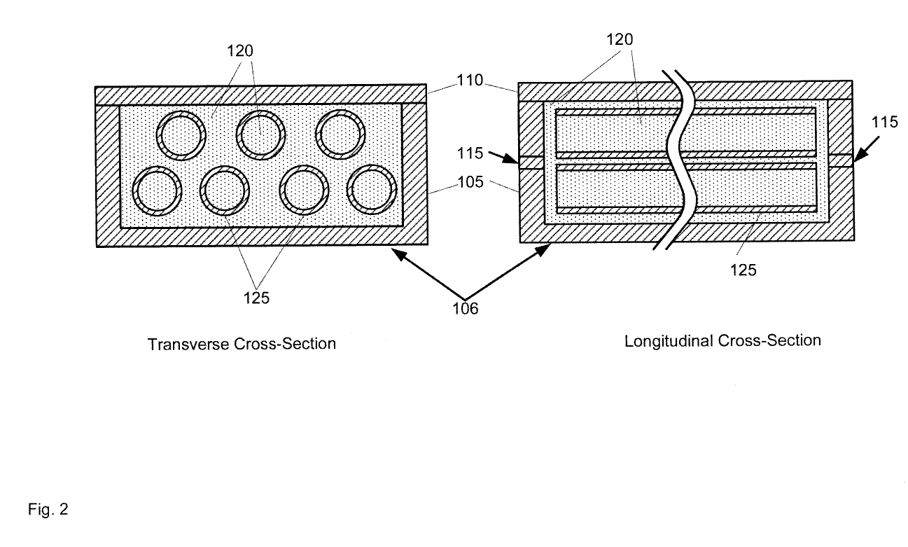

Block 15 will next be described with reference to FIG. 2, which depicts a non-limiting implementation of a reaction vessel 105 that is generally rectangular in both transverse and longitudinal cross-sections, though the shape of reaction vessel is appreciated to be generally non-limiting. Both transverse and longitudinal cross-sections of reaction vessel 105 are shown. As depicted, reaction vessel 105 comprises a body 106, a lid 110, and ventilation openings 115 in body 106. In general reaction vessel 105 is used to implement block 15 of method 10, hence reaction vessel 105 comprises materials that can withstand temperatures used to implement block 15, as described below. Body 106 is generally configured to receive and contain one or more substrates 125 and the tantalum-containing mixture 120, so that the one or more substrates and the tantalum-containing mixture can be heated to deposit tantalum onto the one or more substrates. Lid 110 is generally configured to mate with body 106 in a closed position so that lid 110 and body 106 contain the one or more substrates 125 and the tantalum-containing mixture 120 for heating. FIG. 2 shows reaction vessel 105 in a closed position with lid 110 enclosing a loading aperture of body 106 of reaction vessel 105. Lid 110 can further moved to an open configuration with respect to body 106 so that substrates 125 and tantalum-containing mixture 120 can be loaded into reaction vessel 105. Lid 110 and body 106 can be in any configuration that enables reaction vessel 105 to have both an open configuration for loading and unloading, and a closed configuration to contain the one or more substrates, the tantalum-containing mixture, and reactive gases during the heating. For example, lid 110 can be removably attachable to body 106 using hinges, welding, threading, clamps, and the like

Ventilation openings 115 in body 106 generally enable venting of gaseous reaction by-products of tantalum deposition; such venting prevents pressure from building within reaction vessel 105 during the heating, and assists with regulating the outflow of gaseous by-products of the tantalum deposition. While two ventilation openings 115 are depicted, other numbers, shapes, sizes, and structures of ventilation openings are within the scope of present implementations. For example, a ventilation opening can be coupled to an optional pressure regulator venting apparatus and the like. Alternatively, one or more ventilation openings 115 can be located in lid 110 rather than body 106. In other implementations, ventilation openings 115 can be located in both body 106 and lid 110. In yet further implementations, a ventilation opening 115 can be formed where lid 110 meets body 106 in a closed position; for example lid 110 can mate with body 106 so that gaseous by-products of the tantalum deposition can escape from between lid 110 and body 106 when lid 110 is closed.

Furthermore, depicted reaction vessel 105 is provided as one example only and other types, shapes, and configurations of reaction vessels are within the scope of present implementations.

As depicted in FIG. 2, it is assumed that blocks 11, and 13 have occurred so that a tantalum-containing mixture 120 has been prepared at block 11, and tube shaped substrates 125 have been prepared at block 13. Substrates 125 and tantalum-containing mixture 120 were then placed inside reaction vessel 105, i.e. within body 106. As depicted tantalum-containing mixture 120 was placed in contact with surfaces of substrates 125. Specifically, in FIG. 2, substrates 125, 130 have been immersed in tantalum-containing mixture 120, with the tantalum-containing mixture 120 placed against surface of substrates 125, 130.

The tube shaped substrates 125 is an example shape only. Substrates of other shapes are within the scope of present implementations. Indeed, a substrate of present implementations can have any shape that allows for placing the tantalum-containing mixture 120 in contact with the surfaces of the substrate upon which tantalum is to be deposited. Where the substrate has a multi-faceted surface, the tantalum-containing mixture 120 can be placed in contact with one or more of the facets for deposition of tantalum. Indeed, method 10 can be implemented with substrates having even very complex shapes.

In yet other implementations, tantalum can be deposited only on some, but not all, surfaces of substrates 125; for example, in case of tube shaped substrates 125, tantalum can be deposited on the outer surfaces, and prevented from being deposited on the inner surface, by immersing substrates 125 in tantalum-containing mixture 120 (as depicted in FIG. 2), but filling the inside of tube shaped substrate 125 with the inert filler or other inert materials, instead of tantalum-containing mixture 120. In other words, an inert filler can, in some implementations, be used to mask deposition of tantalum.

While, as depicted, tantalum-containing mixture 120 is in contact with surfaces of substrates 125 where deposition of tantalum is to occur, tantalum can also be deposited on surfaces that do not contact tantalum-containing mixture 120. For example, as in method 10, tantalum is deposited on substrates 125 from a gas phase, e.g. from tantalum vapors and/or tantalum halide vapors, such that tantalum can be deposited on a substrate surface without the tantalum-containing mixture 120 coming into contact with the substrate, so long as the tantalum containing vapors can reach the substrate surfaces.

Furthermore, method 10 can be applied to any size of substrate, as long as reaction vessel 105 is of appropriate dimensions to receive the substrate and/or reaction vessel 105 is of a size that can be heated to effect the reaction. Furthermore, while seven tube-shaped substrates 125 are depicted as being contained in reaction vessel 105, reaction vessel 105 can contain more or fewer than seven substrates. Indeed, a number of substrates which can undergo tantalum deposition at the same time can be determined by the number of substrates that can be accommodated in the reaction vessel 105 with an amount of tantalum-containing mixture 120 sufficient for depositing a sufficient amount of tantalum on the substrates and by the shape and size of the reaction vessel. The capabilities and/or specifications of a given reaction vessel can be determined heuristically.

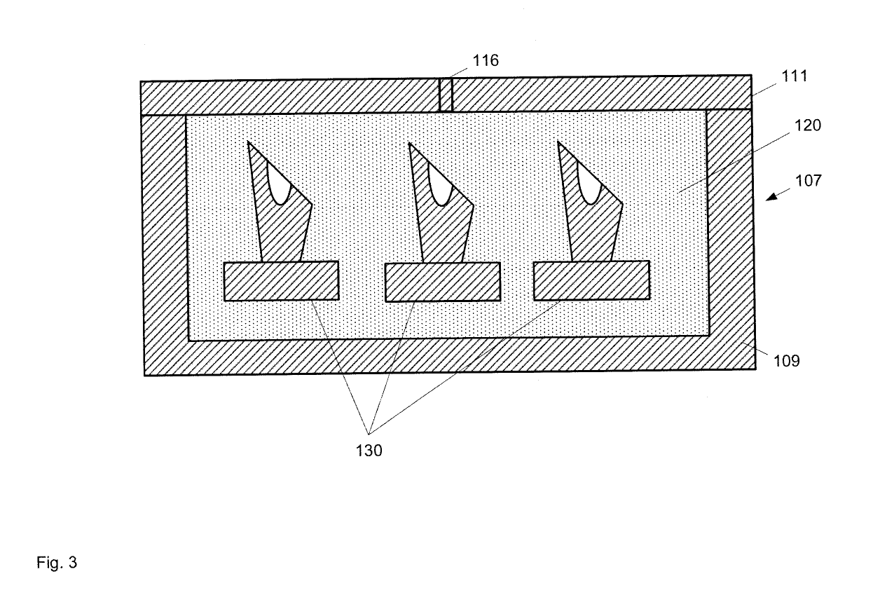

Attention is next directed to FIG. 3 which depicts a cross-section of a reaction vessel 107, comprising a body 109 and a lid 111, respectively similar to body 105 and lid 110, but with one or more ventilation openings in lid 110 rather than body 105. FIG. 3 shows substrates 130 having a complex shape immersed in tantalum-containing mixture 120. In some implementations, substrates 130 can be immersed in tantalum-containing mixture 120 so tantalum-containing mixture 120 surrounds the substrates 130 uniformly with an about even distance between the substrates and between the walls of the reaction vessel 107.

In any event, lid 111 can then be closed, and reaction vessel 107 heated through a heating stage, a soak stage and a cooling stage, causing the tantalum-containing mixture 120 to deposit tantalum on substrates 130, as described in further detail below.

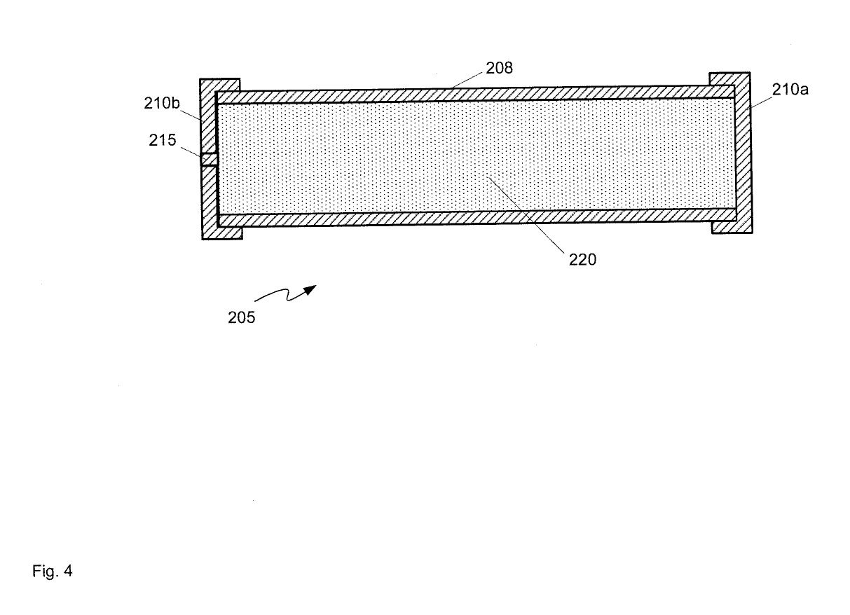

In yet other implementations, tantalum can be deposited on an inner surface of a substrate which is capable of acting as its own reaction vessel. For example, FIG. 4 shows an alternative implementation of a reaction vessel 205. Reaction vessel 205 comprises a tube shaped substrate 208, similar to substrate 125, end caps 210a and 210b, and a ventilation opening 215 in at least one of end caps 210a, 210b.

In this implementation substrate 208 is configured to contain a tantalum-containing mixture 220, similar to that described above, tantalum-containing mixture 220 being packed inside substrate 208, and the two open ends of the tube shaped substrate 208 capped by end caps 210a, 210b. Hence, each of end caps 210a, 210b are of a size and shape for mating with ends of tube shaped substrate 208.

At least one of end caps 210a, 210b comprises a ventilation opening 215, which provides similar functionality as ventilation opening 115. Any numbers, shape, sizes, and structures of ventilation openings are within the scope of present implementations. Alternatively, one or more ventilation openings 215 can be located in one or more both of end caps 210a, 210b. In yet further implementations, a ventilation opening 215 can be formed where one or more of end caps 210a, 210b meets substrate 208; for example end caps 210a, 210b can mate with substrate 208 so that gaseous by-products of the tantalum deposition can escape from between end caps 210a, 210b and substrate 208.

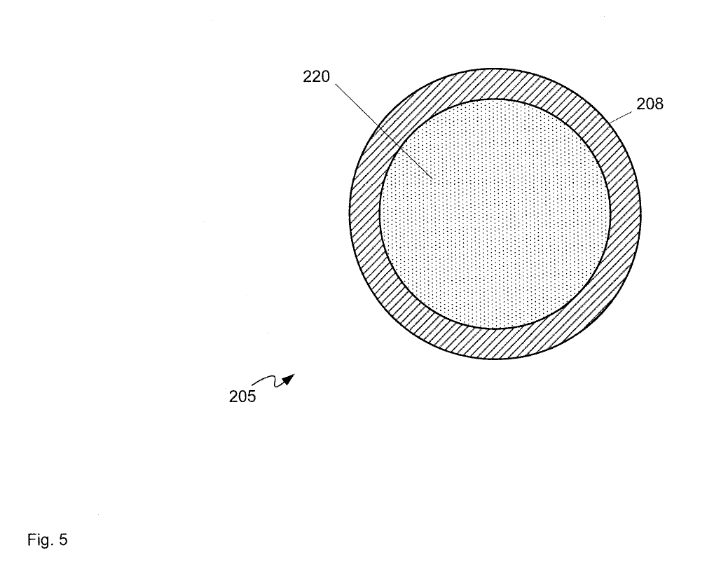

While tube shaped substrate 208 is depicted as having a circular cross-section, for example see FIG. 5, substrate 208 is provided herein as one example only and other types, shapes, and configurations of tube-shaped substrates are within the scope of present implementations. For example a tube shaped substrate can have an irregular cross-section and need not be straight.

Further, as depicted in FIGS. 4 and 5, it is assumed that blocks 11, and 13 have occurred so that tantalum-containing mixture 220 has been prepared at block 11, and tube shaped substrate 208 have been prepared at block 13. Tube shaped substrate 208 was then filled with tantalum-containing mixture 220 and end caps 210a, 210b were used to cap ends of tube shaped substrate 208 to contain tantalum-containing mixture 220 therein. Hence, FIG. 5 shows an axial cross-section of tube shaped substrate 208 filled with tantalum-containing mixture 220.

Once a reaction vessel 105, 205, is prepared, it is then heated in a kiln and/or a furnace and/or any other heating apparatus that can heat reaction vessel 105, 205 to deposit tantalum from a tantalum-containing mixture onto substrates contained therein. The kiln and/or reaction vessel 105 can be heated using heating processes that include, but are not limited to, gas fired heating, electric heating, and the like. In some implementations, reaction vessel 105 can be adapted to comprise a kiln: in other words, heating elements can be provided at body 106 and/or lid 110 (so that contents therein are heated. Such heating elements can generally be provided externally and/or within walls of body 106 and/or within lid 110; in general the heating elements are provided so as they are not in contact with vapours produced during block 15 of method 10.

As the temperature is raised in block 15, the halide activator and tantalum halide activator react, for example similar to Equations 1 and 2 above, and the gaseous products of decomposition of the activators react with Ta in the tantalum-containing mixture. The temperature is increased until a soaking temperature is reached, which can be in a range of about 850° C. to about 1150° C.; soak times can range from about 5 hours to more than 20 hours. The heating rate can depend on the substrate; for example, the heating rate can be controlled so that the substrate is not damaged and/or degraded by the rate of heating. The soak time and temperature can further depend on the dimensions of the substrate and a target thickness of the tantalum coating, as described below.

When processing temperatures are lower than 850° C., the diffusion process and Ta-intermetallide formation can result in tantalum coatings having thicknesses less than about 1 μm and reduced contents of Ta in the intermetallide. When processing temperatures are higher than about 1150° C., degradation can occur in some steels or alloys; for example, Cr containing substrates can undergo Cr depletion which can reduce the ductility, tensile properties, and the overall integrity of the substrate metal. However, presuming a substrate can withstand higher temperatures, and such higher temperatures are within the scope of present implementations.

The atmosphere during heat treatment can be air. There is no need for hazardous gases, such as chlorine, and/or special reducing gases and/or protective environments such as hydrogen, nitrogen, or argon. As a result, there is no need for a control system to regulate the flow and/or ventilation of such gases. In other implementations, an inert or reducing atmosphere can be used. When these gases are used, reaction vessels 105, 107, 205 can be adapted to control the flow of such gases, for example by including an aperture and/or tube to pump such gases into reaction vessels 105, 205.

During the heat treatment of block 15, Ta-rich gases form inside reaction vessels 105, 107, 205, including tantalum containing vapors, from which tantalum is deposited onto the metallic substrate surface, followed by thermal diffusion of the tantalum into the crystalline lattice of the substrate metal. As a consequence of this diffusion, Ta-based intermetallides can form with the metallic elements present in the substrate. These intermetallides can include but are not limited to iron tantalide, nickel tantalide, chromium tantalide and/or more complex intermetallides. The thermal diffusion of the deposited metal into the substrate can occur through at least two mechanisms: 1) diffusion through the vacancies that occur because the substrate material has surface structural defects, and 2) interstitial diffusion that occurs through the crystalline lattice of the substrate material.

After the soaking stage, reaction vessel 105, 107, 205 are cooled during a cooling stage. The cooled reaction vessel 105, 107, 205 is opened (e.g. lid 110/111 is opened and/or removed, and/or end caps 210a, 210b are removed), and the substrates are cleaned of the tantalum-containing mixture, which has now been depleted of tantalum. The substrates can then be placed into corrosive environments where the tantalum coatings provide corrosion resistance.

Method 10 was implemented in a successful prototype and tantalum coatings were applied to metallic substrates, for example flat bars and tubular pieces of stainless steel 316, 304 and other stainless steels, as well as carbon steels; the resulting coatings were analyzed using optical microscopy, scanning electron microscopy (SEM) and X-ray Energy Dispersive Spectrum (EDS) analysis.

The analysis shows that tantalum coatings resulting from method 10 comprises an outer tantalum-rich intermetallide layer having a weight percent of tantalum greater than about 60% and an intermediate transition layer having an intermetallide of tantalum and at least one metal from the metallic substrate, the intermediate transition layer having a weight percent of tantalum in the range of about 35% to about 55%. The outer tantalum-rich intermetallide layer contributes to protecting the metallic substrate against corrosion, while the intermediate transition layer bonds the outer tantalum-rich intermetallide layer to the metallic substrate providing a transition between the outer tantalum-rich intermetallide layer and the substrate (e.g. transition in the values of coefficient of thermal expansions) and also some level of corrosion protection.

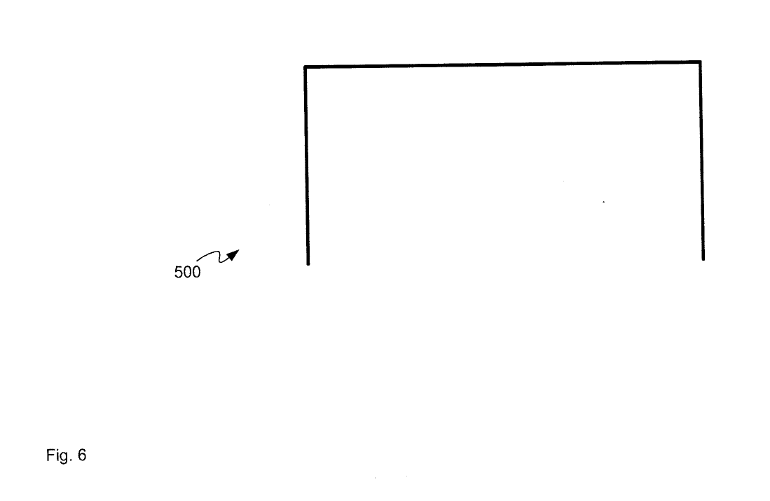

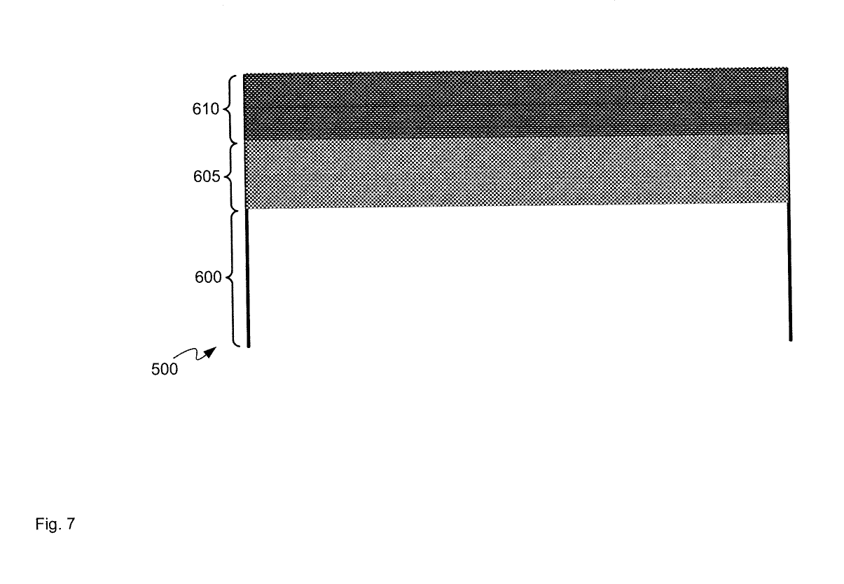

Attention is next directed to FIG. 6, which shows a schematic representation of a substrate 500 with no tantalum coating. FIG. 7 shows a schematic representation of substrate 500 after deposition of a tantalum coating using method 10. Layer 600 represents the substrate in its original composition. Layer 605 represents an intermediate transition layer comprising an intermetallide of tantalum and at least one metal from substrate 500. Layer 610 represents a tantalum-rich intermetallide layer having a higher weight percent of tantalum than intermetallide layer 605. A tantalum coating having a thickness of at least 3 μm was found to provide a reasonable level of protection from corrosion.

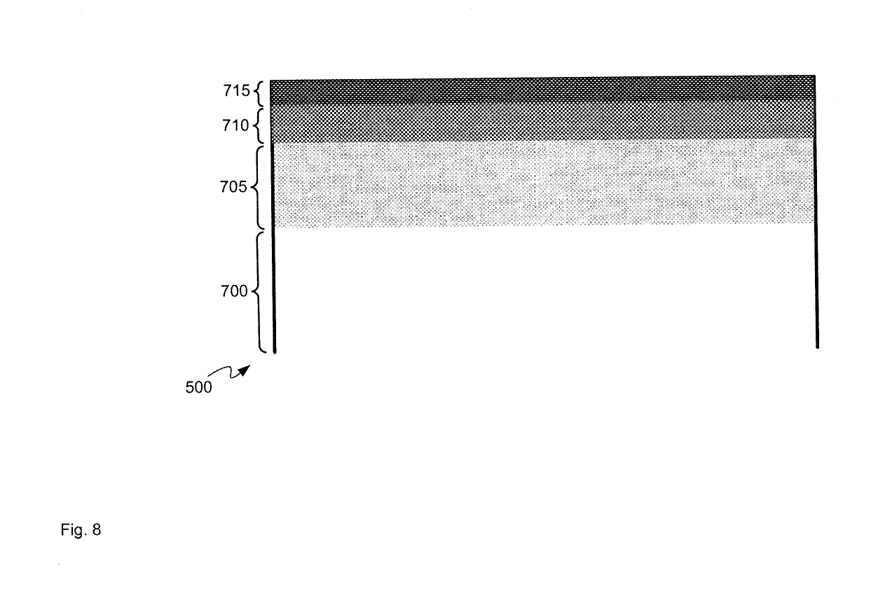

In other implementations, an outer tantalum-rich intermetallide layer produced from method 10 can be comprised of an outer layer (and/or zone) having a weight percent of tantalum in the range of about 70% to about 85% and an inner layer (zone) having a weight percent of tantalum in the range of about 60% to about 70%. FIG. 8 depicts substrate 500 after treated using method 10 in which layer 700 represents the substrate material. Layer 705 represents an intermediate tantalum containing transition layer. Layers (and/or zones) 710 and 715 together represent a tantalum-rich intermetallide layer, with layer (and/or zone) 710 representing an inner layer (and/or zone) of the tantalum-rich intermetallide layer and layer (and/or zone) 715 representing an outer layer (and/or zone) of the tantalum-rich intermetallide layer.

When the outer tantalum-rich intermetallide layer has two layers, the outer layer can have a thickness below 2 μm. The high content of Ta in the coating provides a high level of corrosion resistance, particularly for applications in corrosive and oxidative environments at elevated temperatures in chemical, petrochemical, and power generation industries. Using tantalum coatings instead of components integrally made of tantalum or tantalum alloys significantly lowers the cost of manufacturing tantalum-based corrosion resistant components.

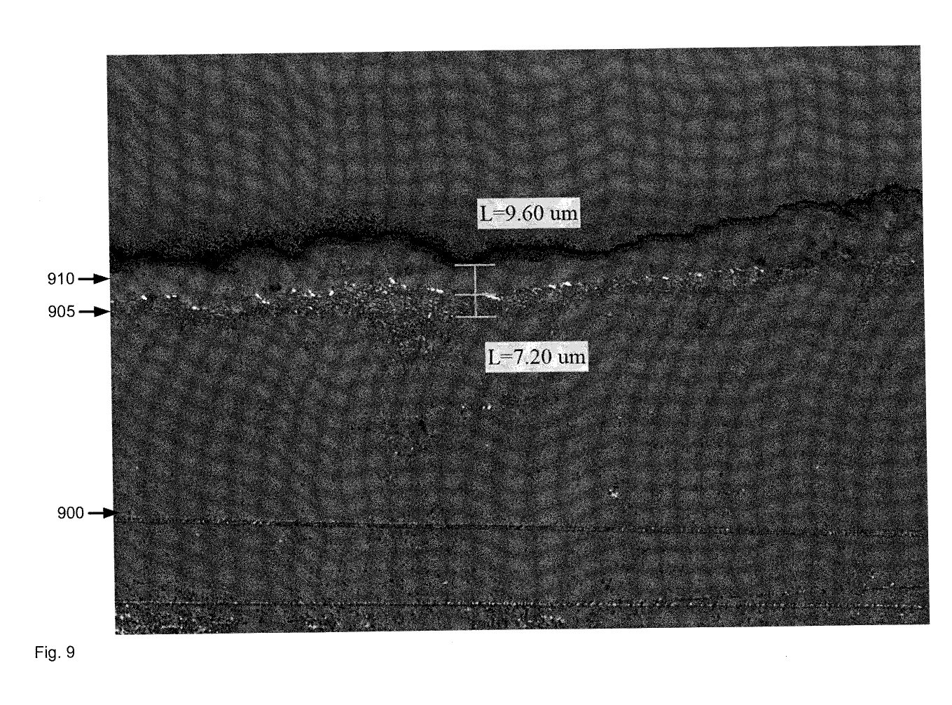

FIG. 9 shows an optical micrograph of a cross-section of a substrate 900 with an outer tantalum-rich intermetallide layer 910 and an intermediate transition layer 905 using method 10. The thicknesses of the outer tantalum-rich intermetallide layer 910 and the intermediate transition layer 905 are measured at one point, as being 9.60 μm and 7.20 μm respectively.

The following examples show non-limiting implementations of successful prototypes of method 10:

### Example 1

Substrates comprising a flat bar and a tubular piece of stainless steel grade 316 (containing Cr and Ni as the major alloying elements) were blasted using glass beads, brushed, then treated with oxalic acid solution for 1.5 minutes at room temperature, washed with acetone, and dried under forced air. The prepared substrate materials were placed into a refractory metallic container (i.e. a reaction vessel) with a prepared powder tantalum-containing mixture, as described below, so the metallic substrate was surrounded about uniformly by the tantalum containing powder. The powder composition had the following ingredients by weight percent, which were blended in a dry state without any accessory media:

| | |
|---|---|
| Ta | 12.9 |
| TaC | 2.6 |
| K₂TaF₇ | 5.0 |
| NH₄Cl | 0.4 |
| NH₄F | 0.1 |
| Al₂O₃ | 79.0 |

The Ta, TaC and K₂TaF₇ powders had particle sizes below 325 mesh. The reaction vessel was placed into an electric kiln and heated up to the temperature of 1000° C. with a soak time of 16 hours. After cooling, the coated substrates were taken from the reaction vessel, a sample was cut from this coated substrate and prepared for analysis using various metallographic procedures, and examined using optical microscopy and SEM. The contents of the elements in the coated substrates were determined using X-ray Energy Dispersive Spectrum (EDS) analysis. The substrates had a tantalum containing layer thickness of about 8-10 μm (determined using the optical microscope), which was even and uniform. No cracks and delamination of the tantalum coating were observed. The coating had two layers: an intermediate transition layer with a thickness of about 3-4 μm adjacent the substrate metal, with a Ta content of about 52% in a transition zone between the intermediate transition layer and the outer coating; and the outer tantalum-rich intermetallide layer with a thickness of about 5-7 μm and with a Ta content of about 73%. The coating also contained Fe, Cr, and Ni from the substrate material. The Fe, Cr and Ni content showed a declining trend from the intermediate transition layer to the outer tantalum-rich intermetallide layer. The obtained high content of Ta in the intermetallide layers, particularly the outer tantalum-rich intermetallide layer, results in a high degree of corrosion resistance.

### Example 2

Substrates comprising a flat bar and a tubular piece of stainless steel grade 304 (containing Cr and Ni as the major alloying elements) were blasted using glass beads, brushed, then treated with diluted hydrochloric acid solution for 0.25 minutes at room temperature, washed with acetone, and dried under forced air. The prepared substrate materials were placed into the reaction vessel with the prepared powder tantalum-containing mixture, so the metallic substrate was surrounded uniformly by the powder. The powder composition had the following ingredients by weight percent, which were blended in a dry state without any accessory media:

| | |
|---|---|
| Ta | 12.9 |
| TaC | 2.6 |
| K₂TaF₇ | 5.0 |
| NH₄Cl | 0.5 |
| Al₂O₃ | 9.0 |

Remaining powder from previous processing cycle 70.0 (i.e. from Example 1)

The Ta, TaC and K₂TaF₇ powders had particle sizes below 325 mesh. The thermal process was conducted as in Example 1 with a soak time of 14 hours and similarly examined. The coated substrates had a tantalum containing layer thickness of about 8-10 μm (determined using optical microscopy), which was even and uniform. No cracks or delamination of the tantalum coating was observed. The tantalum coating had three layers: an intermediate transition layer with a thickness of about 3-4 μm adjacent the substrate metal with a Ta content of about 48%; and an outer layer and an inner layer of an outer tantalum-rich intermetallide. The inner layer had a thickness of about 4-5 μm adjacent the intermediate transition layer and comprised about 66% tantalum; and the outer layer had a thickness of about 2 μm comprising Ta content of about 80%. The coating also contained Fe, Cr, and Ni from the substrate material. The Fe, Cr and Ni content showed a declining trend from the intermediate transition layer to the outer layer of the outer tantalum-rich intermetallide layer. The obtained high content of Ta in the intermetallide layers, particularly the outer layer of the outer tantalum-rich intermetallide layer, results in a high degree of corrosion resistance.

### Example 3

Substrates similar to those in Example 1 were prepared using the same procedure, only diluted phosphoric acid was used for the acid treatment for 0.33 min. The thermal diffusion process was conducted as in Example 2, only the composition of the tantalum-containing mixture was the following:

| | |
|---|---|
| Ta | 10.0 |
| TaC | 2.5 |
| K₂TaF₇ | 5.0 |
| NH₄Cl | 0.5 |
| Al₂O₃ | 9.0 |

Remaining powder from previous processing cycle 73.0

The process temperature was 1020° C. The samples had a tantalum containing layer thickness of about 8-10 μm (determined using optical microscope), which was even and uniform. No cracks or delamination of the tantalum coating was observed. The coating had three layers: an intermediate transition layer with a thickness of about 2-3 μm adjacent the substrate metal with a Ta content of about 50%, and an outer layer and an inner layer of an outer tantalum-rich intermetallide layer. The inner layer had a thickness of about 5-6 μm and was situated adjacent an intermediate transition layer with Ta content of about 67%; and the outer layer had a thickness of about 1.5 μm with Ta content of about 82%. The coating also contained Fe, Cr, and Ni as the major elements from the substrate material. The contents of Fe, Cr and Ni decrease from the transition zone to the outer layer. The obtained high content of Ta in the intermetallide layers, particularly the outer layer of the outer tantalum-rich intermetallide layer, results in a high degree of corrosion resistance.

### Comparative Example 1

The substrates as in Example 1 were prepared using glass beads blasting and then washing in acetone. They were processed using the same tantalum-containing mixture composition and heat treatment procedure as indicated in Example 1. The samples had a tantalum containing layer thickness of about 2-5 μm (determined under microscope), which was thinner and less uniform than the coatings obtained in Examples 1-3. However, no cracks or delamination of the coating was observed. The coating had two layers: an intermediate transition layer with a thickness of about 1-2 μm adjacent the substrate metal and with a Ta content of about 55% in the transition zone; and an outer tantalum-rich intermetallide layer with a thickness of about 1-3 μm and with a Ta content of about 73%. The coating also contained Fe, Cr, and Ni as the major elements related to the substrate material. The Fe, Cr and Ni content showed a declining trend from the intermediate transition layer to the outer tantalum-rich intermetallide layer. Although the content of Ta in the intermetallide layers allows for corrosion resistance of the coating, the level of corrosion resistance is lower than in Examples 1-3 due to the coating being comparatively about 2-2.5 times thinner.

In any event, provided herein is a method for coating metal substrates with tantalum to provide corrosion resistance to the metal substrates. Substrates are prepared to introduce vacancies and then heated, for example using a reaction vessel and/or a kiln, in the presence of a tantalum donor, a halide activator and a tantalum halide activator in the form of a powder. No special environments and/or gases are supplied to the reaction vessel during the heating. The resulting tantalum coatings are bonded to the substrate, resist spalling, and can be applied to surfaces with complex geometries. Furthermore, bonding between the tantalum coating and the substrate is defined by the diffusion-based process when a tantalum intermetallide coating “grows” from the substrate and by the formation of a tantalum-based transition zone. A soak at high temperatures, as described above, provides not only for the formation of the tantalum intermetallides, but also the consolidation of the tantalum intermetallide coating.

Persons skilled in the art will appreciate that there are yet more alternative implementations and modifications possible, and that the above examples are only illustrations of one or more implementations. The scope, therefore, is only to be limited by the claims appended hereto.

1. A method comprising:
preparing a tantalum-containing mixture having:
a tantalum donor;
a halide activator; and,
a tantalum halide activator; and
preparing a substrate for deposition of tantalum from the tantalum-containing mixture; and,
heating the substrate and the tantalum-containing mixture to a given temperature to deposit the tantalum on the substrate.

2. The method of claim 1, wherein the halide activator and the tantalum halide activator each comprise a same halogen; or, the halide activator and the tantalum halide activator each comprise a different respective halogen.

3. The method of claim 1, wherein the tantalum donor comprises a compound selected from the group consisting of tantalum, tantalum carbide, tantalum boride, tantalum nitride, a tantalum intermetallide comprising one or more of Fe, Ti, Cr, Ni, and Nb.

4. The method of claim 1, wherein the tantalum donor comprises a mixture of tantalum powder and a tantalum compound, the tantalum compound selected from the group consisting of tantalum carbide, tantalum boride, tantalum nitride a tantalum intermetallide comprising one or more of Fe, Ti, Cr, Ni, and Nb.

5. The method of claim 4, wherein a ratio of a weight of the tantalum powder to a weight of the tantalum compound is greater than about 2.

6. The method of claim 4, wherein a ratio of a weight of the tantalum powder to a weight of the tantalum compound is greater than about 3.

7. The method of claim 1, wherein the tantalum donor comprises one or more tantalum-containing compounds and an element, the element selected from the group consisting of Nb, Mo, Cr, Ti, Co, Ni, Zr, Hf, and V, the tantalum donor having greater than 50 weight percent of the one or more tantalum-containing compounds.

8. The method of claim 1, wherein the halide activator is selected from the group consisting of ammonium fluoride, ammonium chloride, and ammonium bromide.

9. The method of claim 1, wherein the tantalum halide activator is selected from the group consisting of tantalum fluoride, tantalum chloride, tantalum bromide, K₂TaF₇, and Na₂TaF₇.

10. The method of claim 1, wherein a ratio of a weight of the tantalum halide activator to a weight of the halide activator is greater than about 5.

11. The method of claim 1, wherein a ratio of a weight of the tantalum halide activator to a weight of the halide activator is greater than about 7.5.

12. The method of claim 1, wherein the tantalum-containing mixture further comprises an inert filler.

13. The method of claim 12, wherein the inert filler is selected from the group consisting of Al₂O₃, ZrO₂, TiO₂, and Cr₂O₃.

14. The method of claim 12, wherein the tantalum-containing mixture comprises: a weight percent of the tantalum donor in a range of about 8% to about 50%, a weight percent of a combination of the halide activator and the tantalum halide activator in a range of about 1% to about 20%; and, a weight percent of the inert filler in a range of about 49% to about 91%.

15. The method of claim 12, wherein the tantalum-containing mixture comprises: a weight percent of the tantalum donor in a range of about 10% to about 25%; a weight percent of a combination of the halide activator and the tantalum halide activator in a range of about 3% to about 15%; and a weight percent of the inert filler in a range of about 60% to about 87%.

16. The method of claim 12, wherein the tantalum-containing mixture comprises: a weight percent of the tantalum donor in a range of about 12% to about 18%; a weight percent of a combination of the halide activator and the tantalum halide activator in a range of about 4% to about 10%; and a weight percent of the inert filler in a range of about 72% to 86%.

17. The method of claim 1, wherein preparing the substrate comprises one or more of:
washing the substrate;
mechanical cleaning of the substrate; and,
acid treatment of the substrate.

18. The method of claim 1, further comprising placing the tantalum-containing mixture in contact with surfaces of the substrate prior to the heating.

19. The method of claim 1, wherein the given temperature is in a range of about 850° C. to about 1150° C.

20. The method of claim 1, wherein the substrate and the tantalum-containing mixture are treated at the given temperature for a length of time in a range of about 5 hours to about 20 hours.

21. The method of claim 1, wherein the tantalum-containing mixture comprises a powder.

22. The method of claim 1, wherein the tantalum donor comprises a powder including particles below about 200 mesh.

23. The method of claim 1, wherein the tantalum donor comprises a powder including particles below about 325 mesh.

24. The method of claim 1, wherein the halide activator and the tantalum halide activator each comprises powders including particles below about 200 mesh.

25. The method of claim 1, further comprising, after the heating, reusing the tantalum-containing mixture in a subsequent tantalum deposition after adding at least one of the following to the tantalum-containing mixture: more of the tantalum donor, more of the halide activator, more of the tantalum halide activator, and an inert filler.

26. The method of claim 1, wherein the substrate has a multi-faceted surface and the tantalum-containing mixture is placed in contact with one or more facets of the multi-faceted surface prior to the heating.

27. A metallic substrate having a coating, the coating comprising:
an outer tantalum-rich intermetallide layer having a weight percent of tantalum greater than about 60%, the outer tantalum-rich intermetallide layer protecting the metallic substrate against corrosion; and,
an intermediate transition layer having an intermetallide of tantalum and at least one metal from the metallic substrate, the intermediate transition layer having a weight percent of tantalum in a range of about 35% to about 55%, the intermediate transition layer bonding the outer tantalum-rich intermetallide layer to the metallic substrate.

28. The metallic substrate having a coating according to claim 27, wherein the outer tantalum-rich intermetallide layer comprises:
an outer layer having a weight percent of tantalum in a range of about 70% to about 85%; and,
an inner layer having a weight percent of tantalum in a range of about 60% to about 70%.

29. The metallic substrate having a coating according to claim 28, wherein the outer layer has a thickness below 2 μm.

30. The metallic substrate having a coating according to claim 27, wherein the coating has a thickness of at least 3 μm.
